(19) United States
(12) Patent Application Publication
(10) Pub. No.: US 2025/0086592 A1
(43) Pub. Date: Mar. 13, 2025

(54) UNIFIED AND INTEGRATED DELIVERY PLATFORM

(71) Applicants: Sankaranarayanan Iyem Perumal, Unionville, CT (US); Genevieve M Guilmette, Burlington, CT (US); Sabrina Gortz Carauta de Souza, Old Lyme, CT (US)

(72) Inventors: Sankaranarayanan Iyem Perumal, Unionville, CT (US); Genevieve M Guilmette, Burlington, CT (US); Sabrina Gortz Carauta de Souza, Old Lyme, CT (US)

(21) Appl. No.: 18/466,071

(22) Filed: Sep. 13, 2023

(51) Int. Cl. G06Q 10/10; G06F 8/20; G06F 9/54; G06F 16/93

(52) U.S. Cl. CPC G06Q 10/103; G06F 8/20; G06F 9/541; G06F 16/93

(57) ABSTRACT

According to some embodiments, systems and methods are provided, comprising: creating, via an application workflow component, one or more workflows; storing, by a database storage component, data received from the application workflow component; creating, by an application development component, one or more application products; exchanging, via an integrated delivery platform, Application Programming Interface (API) data with multiple connected components, the API data including one or more API endpoints; executing the created workflow in connection with the application product and outputting data; responsive to the output data, automatically updating a plurality of files stored in the database storage component with the output data; generating at least one report for the updated file; and publishing the at least one report. Numerous other aspects are provided.

### TECHNICAL FIELD

The present application generally relates to computer systems and more particularly to computer systems that are adapted to accurately and/or automatically facilitate enterprise data delivery.

### BACKGROUND

An enterprise may want to facilitate collaborations and communications within and/or between teams and users. In some cases, an enterprise may have thousands of users who each access many different enterprise platforms and/or applications to deliver reports and analytics. However, the features across the platforms and/or applications may not be consistent, resulting in duplicative data/reports being provided across various environments. Further, it may be difficult for consistent messages to be communicated between the different platforms and/or applications.

It would be desirable to provide improved systems and methods to accurately and/or automatically facilitate enterprise collaboration and communication via an integrated delivery platform. Moreover, the data provided by the integrated delivery platform should be easy to access, understand, interpret, update, etc.

### SUMMARY OF THE INVENTION

According to some embodiments, systems, methods, apparatus, computer program code and means are provided to facilitate collaboration and communication among different platforms and/or applications.

Some embodiments are directed to a system and may include a back-end application computer server of an enterprise. The system further comprises: an application workflow component to: create and implement one or more workflows; a database storage component to: provide document management and storage of data received from the application workflow component; an application development component to: build application products; an integrated delivery platform to: connect multiple components and exchange component data and Application Programming Interface (API) data with the multiple components. The backend server component includes: a computer processor; a computer memory, coupled to the computer processor, storing instructions. The instructions, when executed by the computer processor cause the computer processor to: execute a workflow in connection with an application product and output data; responsive to the output data, automatically update, via the integrated delivery platform, a plurality of files stored in the database storage component with the output data; generate, based on the output data, at least one report for the updated file; publish the at least one report. The system further comprises a communication port to facilitate a transmission of data with remote user devices in support of a graphical user display, including a link to the at least one generated report, via a distributed communication network.

Some embodiments are directed to a method and may include creating, via an application workflow component, one or more workflows; storing, by a database storage component, data received from the application workflow component; creating, by an application development component, one or more application products; exchanging, via an integrated delivery platform, Application Programming Interface (API) data with multiple connected components; executing the created workflow in connection with the application product and outputting data; responsive to the output data, automatically updating a plurality of files stored in the database storage component with the output data; generating at least one report for the updated file; and publishing the at least one report.

Other embodiments are directed to a non-transitory, computer-readable medium storing instructions that, when executed by a processor, cause the processor to perform a method including: creating, via an application workflow component, one or more workflows; storing, by a database storage component, data received from the application workflow component; creating, by an application development component, one or more application products; exchanging, via an integrated delivery platform, Application Programming Interface (API) data with multiple connected components, the API data including one or more API endpoints; executing the created workflow in connection with the application product and outputting data; responsive to the output data, automatically updating a plurality of files stored in the database storage component with the output data; generating at least one report for the updated file; and publishing the at least one report.

In some embodiments, a communication device associated with a backend server component exchanges information with an integrated delivery platform in connection with an interactive graphical user interface. The information may be exchanged, for example, via public and/or proprietary communication networks.

A technical effect of some embodiments of the invention is an improved and computerized way to accurately and/or automatically facilitate the exchange of data and reporting from multiple platforms and/or applications in a way that provides fast and useful data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of an integrated delivery tool in accordance with some embodiments.

FIG. 2 is a flow diagram according to some embodiments.

FIG. 3 is a non-exhaustive example of stored metadata and a stored managed document library according to some embodiments.

FIG. 4 is an integrated delivery tool display according to some embodiments.

FIG. 5 is another integrated delivery tool display according to some embodiments.

FIG. 6 is an integrated delivery tool display of a detailed report page according to some embodiments.

FIG. 7 is an integrated delivery tool display of a validation request according to some embodiments.

FIG. 8 is an integrated delivery tool display of a report page for a publisher according to some embodiments.

FIG. 9 is another integrated delivery tool display including a publisher insight pop-up window according to some embodiments.

FIG. 10 is an integrated delivery tool display including a report version pop-up window according to some embodiments.

FIG. 11 is a block diagram of an apparatus in accordance with some embodiments.

FIG. 12 illustrates a tablet computer providing an integrated delivery tool display according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data processing associated with an integrated delivery tool. The present invention is directed to more than merely a computer implementation of a routine or conventional activity previously known in the industry as it provides a specific advancement in the area of electronic record analysis by providing improvements in the operation of a computer system that teams can more easily and efficiently access information about, and output by, enterprise platforms and/or applications. The present invention provides improvement beyond a mere generic computer implementation as it involves the novel ordered combination of system elements and processes to provide improvements in the speed, security, and accuracy at which such information may be shared. Some embodiments of the present invention are directed to a system adapted to automatically analyze electronic records, aggregate data from multiple sources, and distribute data via dashboards, etc. to reduce unnecessary messages or communications, etc. (e.g., to consolidate data). Moreover, communication links and messages may be automatically established, aggregated, formatted, modified, removed, exchanged, etc. to improve network performance (e.g., by reducing an amount of used network messaging bandwidth and/or storage required to create and send reports and report messages and/or alerts, improve security, reduce the size of a data store, etc.).

Embodiments provide an integrated delivery tool to facilitate consistent reporting and security features across multiple platforms and methods used for information delivery. The integrated delivery tool may connect multiple components via API endpoints to provide a standardized connection between the components at least with respect to security and reporting. For example, instead of creating separate security authorizations between component A and component B, and component A and component C, each component is connected to the integrated delivery tool, and the integrated delivery tool provides for the security authorizations between the components. As another example, instead of multiple components providing their own messaging, each component is connected to the integrated delivery tool, and the integrated delivery tool provides the messages in a consistent format.

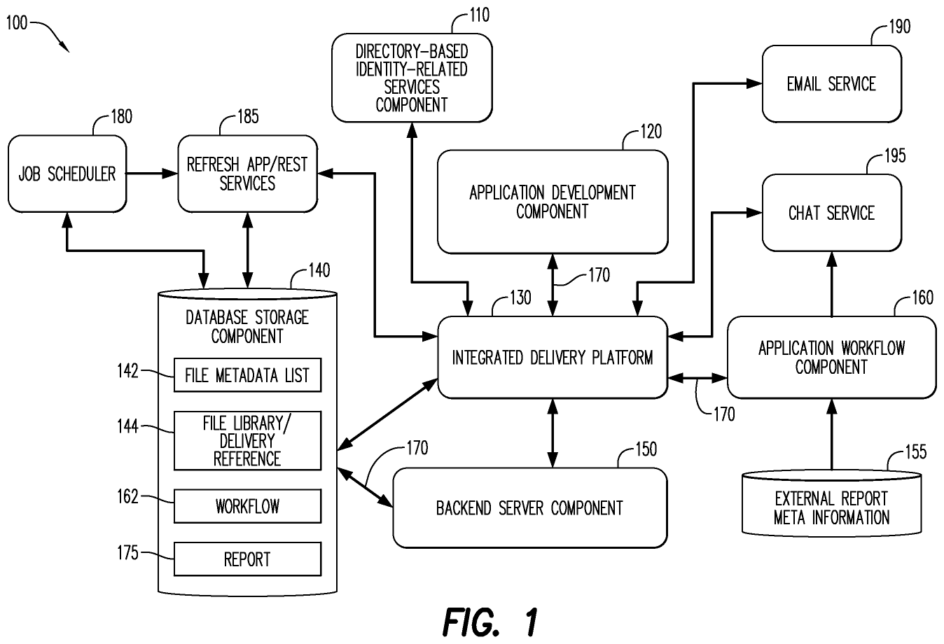

FIG. 1 is a high-level block diagram of an integrated delivery tool or system 100 according to some embodiments of the present invention. In particular, the system 100 includes a directory-based identity-related services component 110, an application development component 120, an integrated delivery platform 130, a database storage component 140, a backend server component 150 and an application workflow component 160.

The directory-based identity-related services component 110 may authenticate and authorize users and computers in a network, as well as assign and enforce security policies. For example, limiting access to particular reports/collections to people within a given group and/or particular individuals.

The application development component 120 may provide for users to build and share one or more custom low-code application products (e.g., an application). Non-exhaustive examples of the application development component 120 include Power Apps® by Microsoft®. Non-exhaustive examples of an application product use case built using the application development component 120 may be an actuarial application product to analyze financial lines for an enterprise.

The integrated delivery platform 130 may connect multiple components and exchange component data (e.g., output data 170) and Application Programming Interface (API) data with the multiple components, as well as store component data. Pursuant to embodiments, the integrated delivery platform 130 may facilitate the connection of the multiple components via the exchanged API data, including API endpoint(s). The API data may be transmitted to and from different API endpoints associated with the components. The API endpoints allow the data to be seamlessly exchanged without having to set up each individual component to be able to interact with the other components.

For example, the integrated delivery platform 130 standardizes the security for all the different components via application of the directory-based identity-related services component 110. As the requests and data pass through the integrated delivery platform 130, the integrated delivery platform 130 confirms the security of the requests/data with the directory-based identity-related services component 110. This is in contrast to conventional systems where each component has its own security protocol. In addition to providing access to a file, the integrated delivery platform 130 may also provide for a file to be published to a user. As with conventional security protocols, different components conventionally have their own publishing processes. The integrated delivery platform 130 also standardizes the publishing processes for the different components. Further, a communication may be sent when the file is published, and other alerts may be similarly communicated.

The system 100 may store information into and/or retrieve information from the data storage component 140 via the integrated delivery platform 130. The integrated delivery platform 130 might be locally stored or reside remote from other elements of the system 100. As will be described further below, the integrated delivery platform 130 may be used by the system 100 in connection with an interactive user interface to access and update electronic records. Although a single integrated delivery platform 130 is shown in FIG. 1, any number of such devices may be included. Moreover, various devices described herein might be combined according to embodiments of the present invention. For example, in some embodiments, the directory-based identity-related services component 110 and the integrated delivery platform 130 might be co-located and/or may comprise a single apparatus.

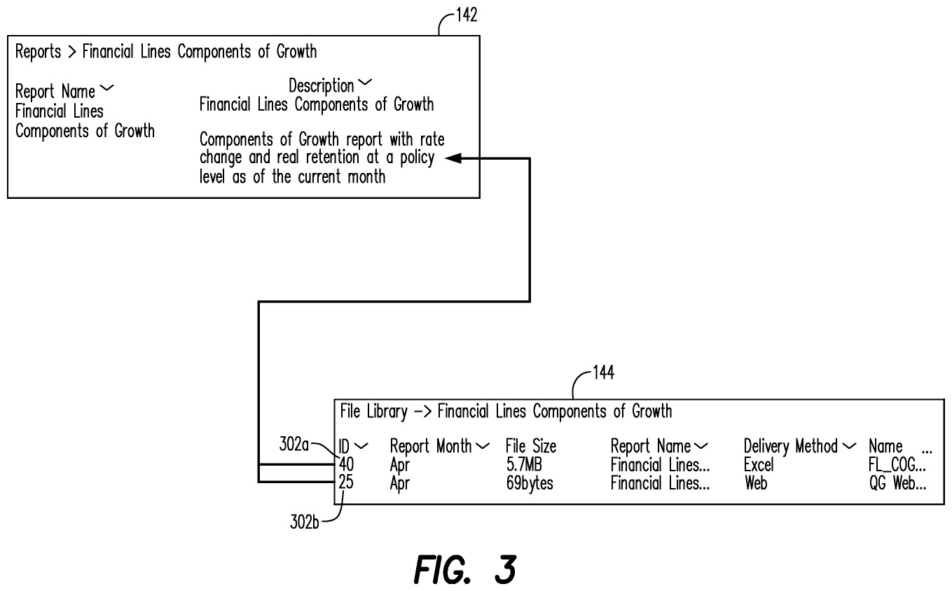

According to some embodiments, storage may be achieved via the database storage component 140, Structured Query Language (“SQL”) element, or any other suitable database or storage solution, etc. The database storage component 140 may provide document management and storage of data received from the application workflow component and other components. The database storage component 140 may be cloud-based and may exchange secure storage data with the application development component 120 and the backend server component 150 via the integrated delivery platform 130. The database storage component 140 may also directly exchange data with the backend server component 150. The database storage component 140 may include a file metadata list 142 and a file library/delivery reference 144. The file metadata list 142 includes information that describes a particular file including, but not limited to, its name, size, type, date, author, location and tags. The file library/delivery reference 144 includes information for a plurality of files including, but not limited to, a file identifier, a file size, a report month, a report name, a method of delivering the file (e.g., Excel®, Web, etc.). FIG. 3 is a non-exhaustive example of the file metadata list 142 and the file library/delivery reference 144. Herein, both of the files 302a and 302b in the file library/delivery reference 144 are reports delivered with the same data but via different delivery methods. As shown, file 302a with ID 40 was delivered via Excel® and file 302b with ID 25 was delivered via Web. Further, since both files 302a and 302b are reports created with the same data, they are mapped to the same entry in the file metadata list 142.

Additionally, the database storage component 140 may provide document/data sharing and management and storage of data received from the application workflow component 160 via the integrated delivery platform 130. A non-exhaustive example of the data storage component 140 is SharePoint® by Microsoft®.

The application workflow component 160 may provide for a user to create and implement one or more workflows 162. A workflow 162 is a set of steps or tasks to complete a specific process within an enterprise. The workflow 162 may define the sequence of tasks, who is responsible for each task, and what tools or resources are required to complete the task. A given workflow 162 may be complex and include multiple tasks that may be dependent on each other. Additionally, the given workflow 162 may include different tasks depending on other parameters. The application workflow component 160 may automate the steps of the workflow, including switching applications to perform the tasks, synchronizing data and files, collecting data, etc. A non-exhaustive example of an application workflow component 160 may be Power Automate® by Microsoft®

Moreover, a computer processor of the backend server component 150 may automatically execute a workflow 162 in connection with an application product of the application development component 120 to output data 170. The execution of the workflow 162 may be initiated by a job scheduler 180. The job scheduler 180 provides for the workflow (and each of the tasks included therein) to occur at specific times or in response to a specific triggering event. At the given specific time (or responsive to the specific triggering event), the job scheduler 180 may select the particular workflow to be brought into a queue for execution. The job scheduler 180, in addition to selecting the particular workflow 162, may also pull appropriate data from the database storage component 140 to execute the workflow 162. Execution of the workflow 162 may occur via a refresh app/REST (representational state transfer) API service 185 per the processor of the backend server component 150. In some embodiments, the refresh app/REST API service 185 may upload a file from the database storage component 140 as identified by the job scheduler 180 prior to execution of the workflow 162, download a file to the database storage component 140 after executing the workflow 162, and/or refresh a file (e.g., identify changes from a previous version).

Pursuant to some embodiments, and responsive to the output data 170 generated by execution of the workflow 162, the computer processor may automatically update a plurality of files stored in the database storage component 140 with the output data 170. In some embodiments, the update/refresh may or may not be via the refresh app/REST services 185.

At least one report may be generated for the updated file(s) and then that report may be published by the computer processor. The report may be generated by an application product via the backend server component 150. The backend server component 150 may transmit the output data and/or report to the integrated delivery platform 130 via a communication port in support of a graphical user display (including the report information) via a distributed communication network.

The system 100 may therefore access information via the integrated delivery platform 130 (e.g., the data storage component 140 storing a set of electronic records associated with enterprise data, each record including, for example, one or more record identifiers, etc.). The files in the file library may be a non-exhaustive example of electronic records. The system 100 may also store information into other data stores and utilize a runtime environment to view, analyze, and/or update the electronic records. The system 100 may also exchange information with a cloud-based environment (e.g., via a firewall) executing a family of client software, server software, and services or may exchange information with a remote user device (e.g., via the firewall). The system 100 may also exchange information via communication links (e.g., via a communication port that may include a firewall) to communicate with different systems. Further, the system 100 may also transmit information directly to an email server 190, chat service 195, user application, a voice recognition application and/or calendar application (e.g., to generate reminders about publishing reports) to facilitate automated communications and/or other actions. This information may be used by the system 100, for example, to automatically establish a channel of communication with an employee, automatically transmit a message to a manager and/or team member, etc. According to some embodiments, an interactive graphical user interface platform of the system 100 (and, in some cases, enterprise data and/or third-party data) may facilitate forecasts, decisions, predictions, alerts and/or the display of results and/or communications via one or more remote administrator computers (e.g., to identify appropriate updates to the data) and/or the remote user device. For example, the remote user device may transmit updated information (e.g., a validation instruction, a publisher comment, etc.) to the backend server component 150 of the system 100. Based on the updated information, the backend server component 150 may adjust data in the data storage component 140, and the change may (or may not) be used in connection with other systems and/or components. Note that the system 100 and/or any of the other devices and methods described herein might be associated with a third party, such as a vendor that performs a service for an enterprise.

The system 100 and/or the other elements of the system 100 might be, for example, associated with a Personal Computer (“PC”), laptop computer, smartphone, an enterprise server, a server farm, and/or a database or similar storage devices. According to some embodiments, an “automated” system 100 may facilitate automated generation of data and reports. As used herein, the term “automated” may refer to, for example, actions that can be performed with little (or no) intervention by a human.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Note that the system 100 of FIG. 1 is provided only as an example, and embodiments may be associated with additional elements or components. According to some embodiments, the elements of the system 100 automatically transmit information associated with an interactive user interface display over a distributed communication network. User interface displays 400, 600, 700 and 800 (and any other interfaces herein) may be presented on any type of display apparatus (e.g., desktop monitor, smartphone display, tablet display) provided by any type of client device (e.g., desktop system, smartphone, tablet computer). The application, which is executed to provide user interface displays 400, 600, 700 and 800 (and any other interfaces herein), etc., may comprise a Web Browser, a standalone application, or any other application. Embodiments are not limited to user interface displays 400, 600, 700 and 800 (and any other interfaces herein), etc.

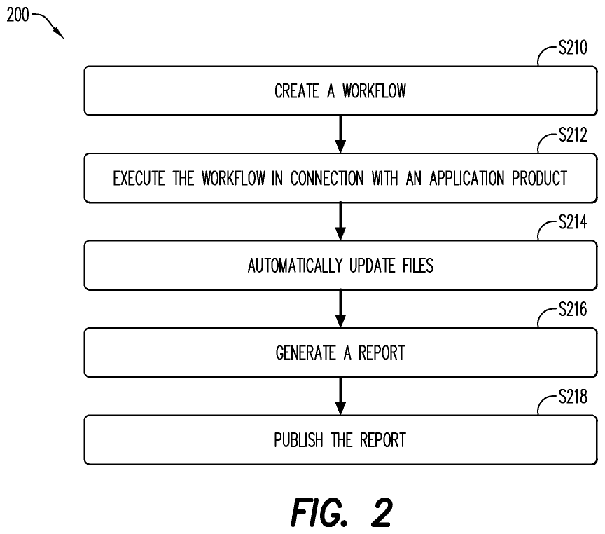

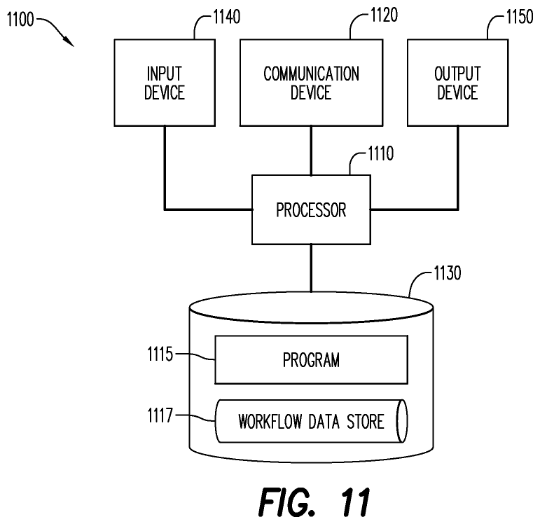

FIG. 2 illustrates a process 200 that might be performed by some or all of the elements of the system 100 described with respect to FIG. 1, or any other system, according to some embodiments of the present invention. In one or more embodiments, the system 100 may be conditioned to perform the process 200 and any other processes described herein, such that a processor 1110 (FIG. 11) of the system 100 is a special purpose element configured to perform operations not performable by a general-purpose computer or device. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thercon instructions that when executed by a machine result in performance according to any of the embodiments described herein. The instructions may be embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to execution of the method 200, an application product is built with the application development component 120. As a non-exhaustive example, the application product may be an actuarial application product to analyze financial lines for an enterprise. The actuarial application product may generate a report to analyze the financial lines for an enterprise.

Initially, at S210, a workflow 162 is created via the application workflow component 160. Pursuant to some embodiments, the application workflow component 160 may use data from an external report meta information database 155 to approve the created workflow 162. For example, the external report meta information database 155 may include historical workflow meta information that may be used to analyze the created workflow 162. As described above, the workflow 162 may include a plurality of tasks. The data storage component 140 may store a set of electronic records associated with tasks included in different workflows. Each record includes, but is not limited to, a task identifier and a plurality of parameters. A file may be formed from a plurality of related records.

Then at S212, the workflow 162 is executed in connection with the application product by the backend server component 150. As described above, execution of the workflow may be initiated by the job scheduler 180. During execution of the workflow, the application product may retrieve data for the tasks that is stored in the data storage component 140. The interaction between the components may be facilitated by the integrated delivery platform 130. The executed workflow generates output data 170. Continuing with the non-exhaustive example of a product to analyze financial lines for an enterprise, the output data may include financial lines data for components of growth (COG) for a prior year, financial lines data for COG for a current year, Financial Lines COG Data for a second prior year, etc. The execution may include the exchange of API data between each component (e.g., the data storage component 140, the application product of the application development component 120, the workflow of the application workflow component 160, and the backend server component 150) and the integrated delivery platform 130. The exchange of the API data may use API endpoints, permissions and authentication. The permissions may represent application permissions/not delegated and require administrator consent. The authentication type may include, but is not limited to, Active Directory, OAuth (Active Directory Open Authorization), client identifier, certificate and/or secret. OAuth is an open, standardized protocol for internet token-based authorization. The authentication may manage access to the electronic records associated with the tasks in a more secure manner than if the authentication was not present.

In response to generation of the output data 170, the generated output data 170 is transmitted to the database storage component 120, via the integrated delivery platform 130, and one or more files stored in the database storage component 140 are automatically updated at S214.

At S216, another application product of the application development component 120 is executed by the backend server component 150, as facilitated by the integrated delivery platform 130, and generates a report 175 based on the output data 170. The report 175 and the API data are transmitted to the database storage component 120 via the integrated delivery platform 130.

It is noted that the order of steps S214 and S216 may be reversed. Alternatively, the order of steps S214 and S216 may not be sequential, and instead may occur at the same time or substantially the same time.

Then, at S218 the report is published and may be accessible to a user via a Graphical User Interface (“GUI”).

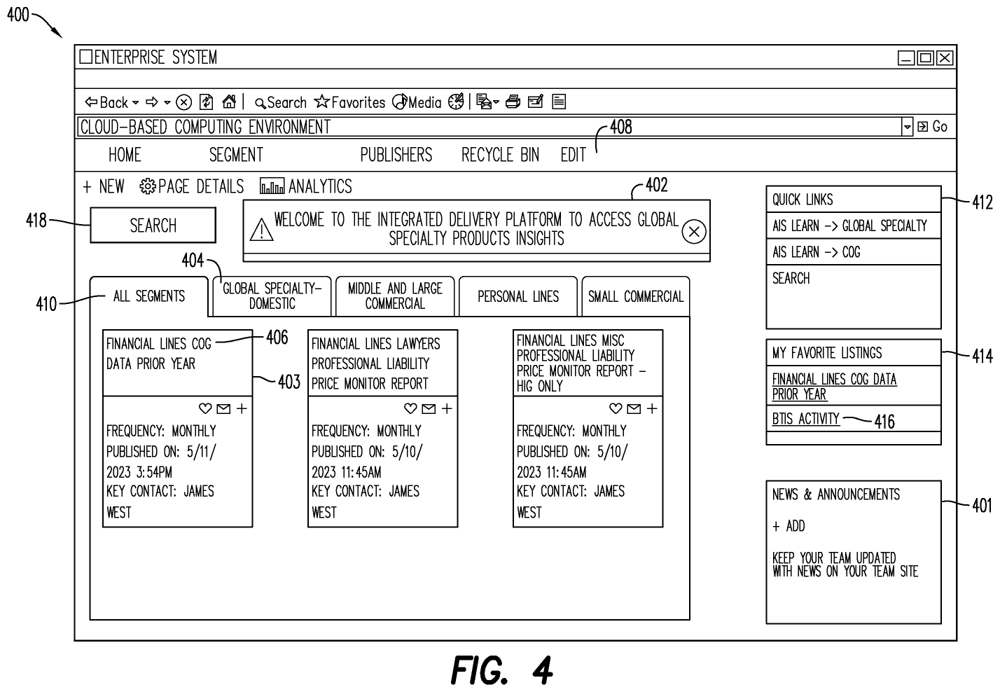

FIG. 4 illustrates a graphical user interface display 400 with a Welcome Dashboard for a user according to some embodiments. The display 400 may include news 401 and alerts 402 that may be associated with at least one of the welcome dashboard, a segment 404 and a report 406. It is noted that the alert may be associated with positive and negative information. Here, the alert is a welcome message that indicates the context (e.g., Global Specialty Products) for the displayed information. It is noted that any user may create an alert, unlike conventional systems that require a developer to create an alert.

The display 400 may include a menu bar 408 including selectable elements (e.g., Home, Segment, Publishers, Recycle Bin, Edit). Selection of a portion of the display (e.g., via a touchscreen or computer mouse pointer) may provide more detailed information about that element (e.g., tab 410). The display 400 may be populated with data captured for all reports such that the displayed content may be manipulated to be part of a particular user collection. The display may include a plurality of tiles 403 that roll up to a given segment 404. Each tile 403 may represent a report 406 (e.g., Financial Lines COG Data Prior Year, Financial Lines Lawyers Professional Liability Price Monitor Report, etc.). Each tab 410 may represent a different segment 404 or, in the case of the “All Segments” tab, may represent all of the segments. Based on the selected tab 410, the display may display one or more reports 406. Here, the Global Specialty tab 410 is selected, and three tiles, each representing a report, are displayed. In some embodiments, the backend server component 150 via the integrated delivery platform 130 may implement a report “aging” view whereby reports that are not updated for a pre-defined amount of time (e.g., a month or more) may not be included in the dashboard, even if they roll-up to a given segment. The display 400 may also include a quick links panel 412 and a “My Favorite Listing” panel 414, each including selectable links 416. A “Search” icon 418 may be included in the display 400 to search for a particular report or a particular metric. Note that the embodiment disclosed in FIG. 4 is provided only as an example and other embodiments may incorporate other types of information.

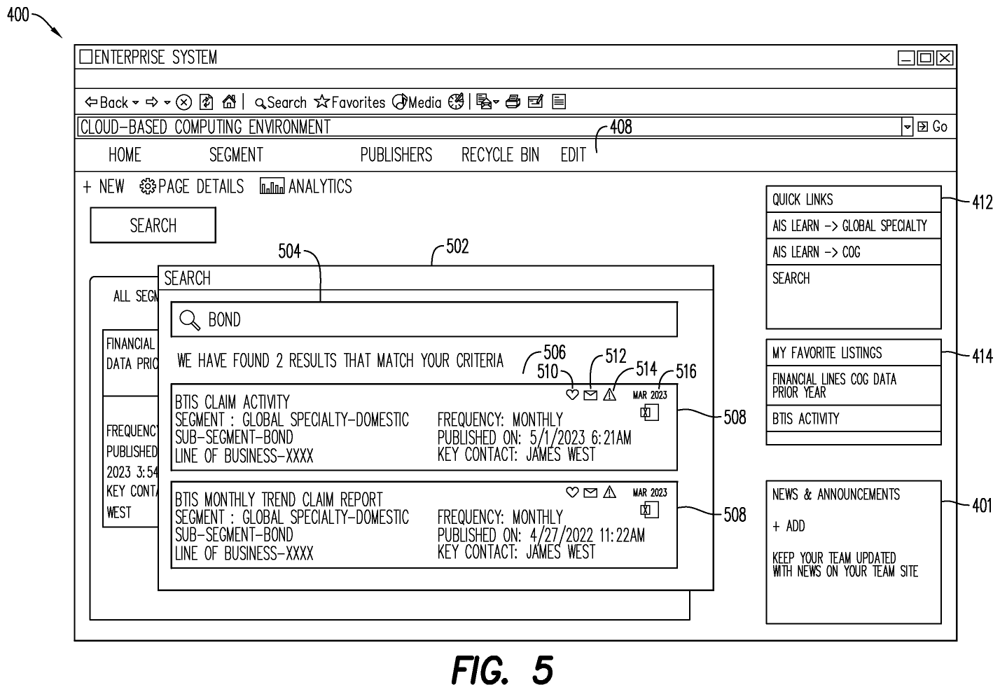

Selection of the “Search” icon 418 may result in the display of a pop-up search window 502 as shown in FIG. 5. The search window 502 may include a data entry search box 504 and a result section 506. Here, the search term is “bond”, and the result section 506 includes two results 508: a BTIS Claim Activity report and a BTIS Monthly Trend Claim Report. Each result 508 may include several selectable icons, including, but not limited to, a heart icon 510, an envelope icon 512, and an alert icon 514. Selection of the heart icon 510 may add the result to the “My Favorite Listing” panel 414. Selection of the envelope icon 512 may subscribe the user to the result 508 such that the user will be notified via email when the result/report is refreshed. Pursuant to some embodiments, in a case a user is subscribed to multiple reports, the received email notification may consolidate the reports that are refreshed on the same date, such that one email notification is transmitted to the user with all of the updated reports for that date. In other embodiments, a separate email notification is transmitted to the user for each updated report. In a case the alert icon 514 is selectable (e.g., not grayed-out), selection of the alert icon 514 will display to the user any alerts currently associated with the result/report. Each result 508 may also include an embedded result link 516. Selection of the embedded result link 516 may provide direct access to the result/report.

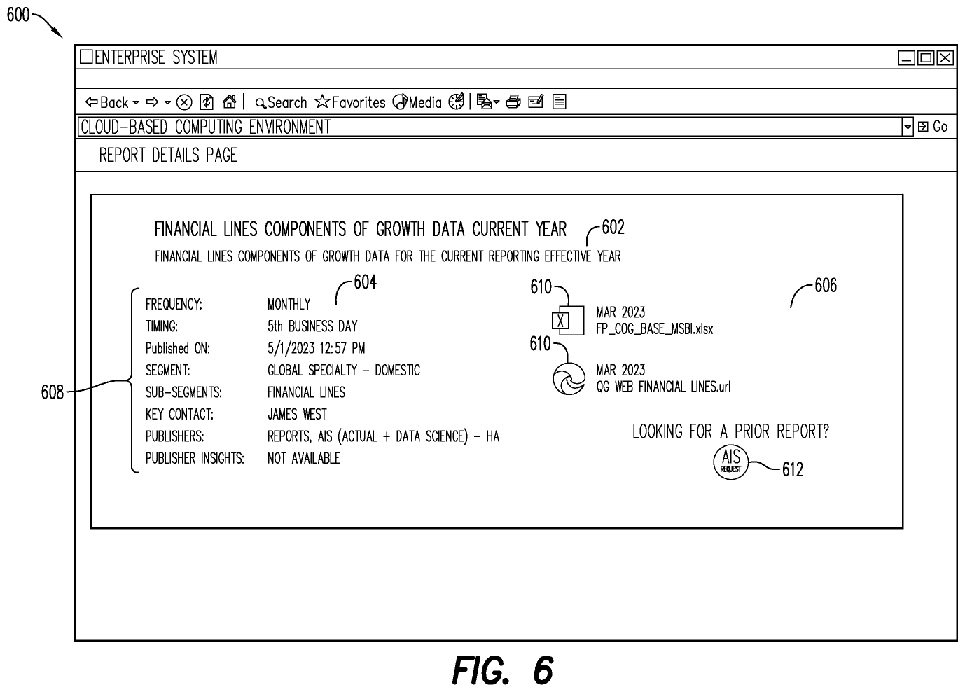

FIG. 6 illustrates a graphical user interface Report Details Page display 600 according to some embodiments. According to some embodiments, the Report Details Page display 600 is displayed in response to selection of a tile 403 on the Welcome Dashboard display 400. The display 600 may include a report title 602. The report title 602 may be refreshed from the title on the tile, as on the Report Detail Page display 600, the report title 602 may provide a more comprehensive description, avoiding acronyms (e.g., “Components of Growth” instead of “COG”). The Report Details Page display 600 may also include a details panel 604 and a report panel 606. The details panel 604 may include a plurality of details 608 including, but not limited to, a report cycle and estimated delivery (here, monthly and 5th business day, respectively), publishing date, segment and sub-segment (here, May 1, 2023 at 12:57 PM, Global Specialty-Domestic, Financial Lines, respectively), a key contact (here, James West), a publisher distribution list (when applicable) (here, Reports, AIS (Actuarial+ Data Sciences) and publisher insights, which are notes for the user (here, not available). It is noted that metadata and tags of the details 608 may be used as search parameters and may improve data organization. The report panel 606 may include various delivery methods 610 for the same data in a single view, where the delivery method is a particular report type (e.g., Excel®, Microsoft Business Intelligence (MSBI)®, a web link, Tableau®, etc.). Here, the two delivery methods 610 are Excel® and Web®. The data for a particular metric (e.g., Components of Growth), as generated by execution of the workflow 162, may be stored in the database storage component 140. Then, when the delivery method 610 is selected, the report is presented in real-time per the selected delivery method 610, via the integrated delivery platform 130. In this way, multiple reports may be mapped to the same data and instead of transmitting multiple reports in multiple formats, selecting the format links the user directly to the desired report, thereby reducing used bandwidth. All of the possible formats available for a given metric may be available to a user.

The report panel 606 may also include a “Prior Report” icon 612. Selection of the “Prior Report” icon 612 may allow a user to request a previously generated report of the same report type for display. As a non-exhaustive example, here the Financial Lines Components of Growth data Current Year report was published on May 1, 2023, and selection of the “Prior Report” icon 612 may allow the user to request the Financial Lines Components of Growth data Current Year report published on Apr. 1, 2023.

Pursuant to some embodiments, the report may be automatically published to a user unless the report has been flagged during creation of the report as needing validation by the report publisher. The flag may be a checkbox, a rule or any other suitable indicator indicative of a report requiring validation prior to publication. In a case validation is required for a report, the user will not see the refreshed report until it is published. As part of the validation, the publisher may manually review the results/report and then publish the latest version of the result/report. In some embodiments, validation may only be available for Excel® reports (e.g., not Web links or MSBI-type reports), while in other embodiments validation may be available for Excel® reports and other types of reports.

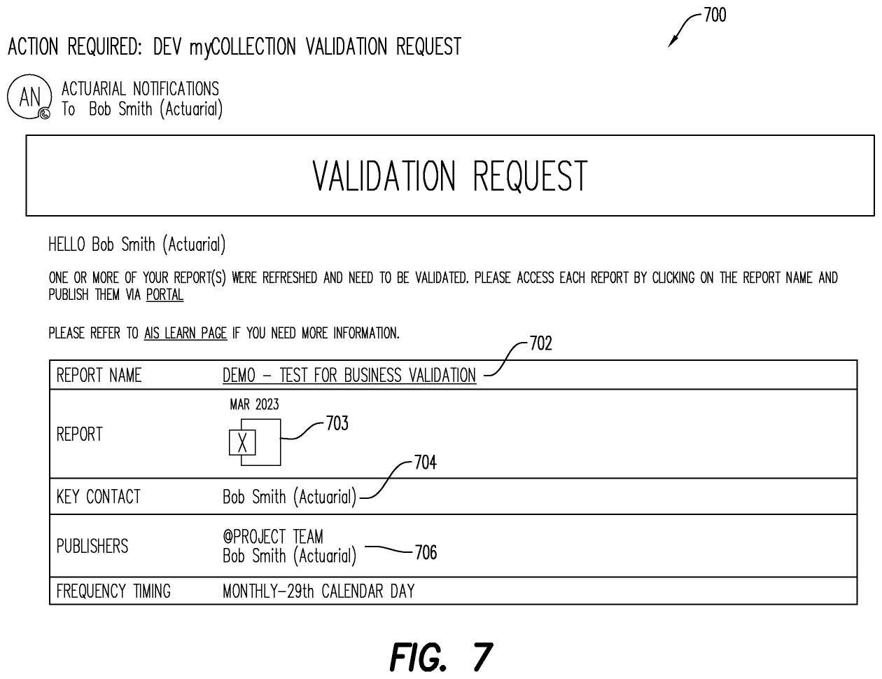

The publisher may receive notification that a report was executed and needs to be validated. The notification may be an email or other suitable notification. FIG. 7 illustrates a non-exhaustive example of validation request notification 700 (“notification”). The notification 700 may be presented as a user interface display. The notification 700 may include an embedded report name link 702, a report type (here Excel®), an embedded report link 703, an embedded key contact link 704, an embedded publisher link 706 and a frequency-timing indicator of the report. Selection of the embedded report link 703 may result in generation, by the email server 190, of an email message that includes the report. Selection of the embedded key contact link 704 may result in generation, by the email server 190, per the integrated delivery platform 130, of an email message addressed to the key contact. It is noted that while the non-exhaustive example shown in FIG. 7 lists the person receiving the notification and the key contact and one of the publisher's as the same person (Bob Smith), other examples may have the person receiving the notification be a different person from the key contact and/or publisher. Additionally, the key contact may be a person or a group (e.g., Project_Team). Similarly, selection of one of one or more embedded publisher links 706 (here, @Project_Team and Bob Smith) may result in generation, by the email server 190, per the integrated delivery platform 130, of an email message communication interface addressed to the selected publisher. It is further noted that selection of any of the embedded key contact link 704 or the embedded publisher link 706 may result in generation of a TeamsChat® window, or other suitable communication interface.

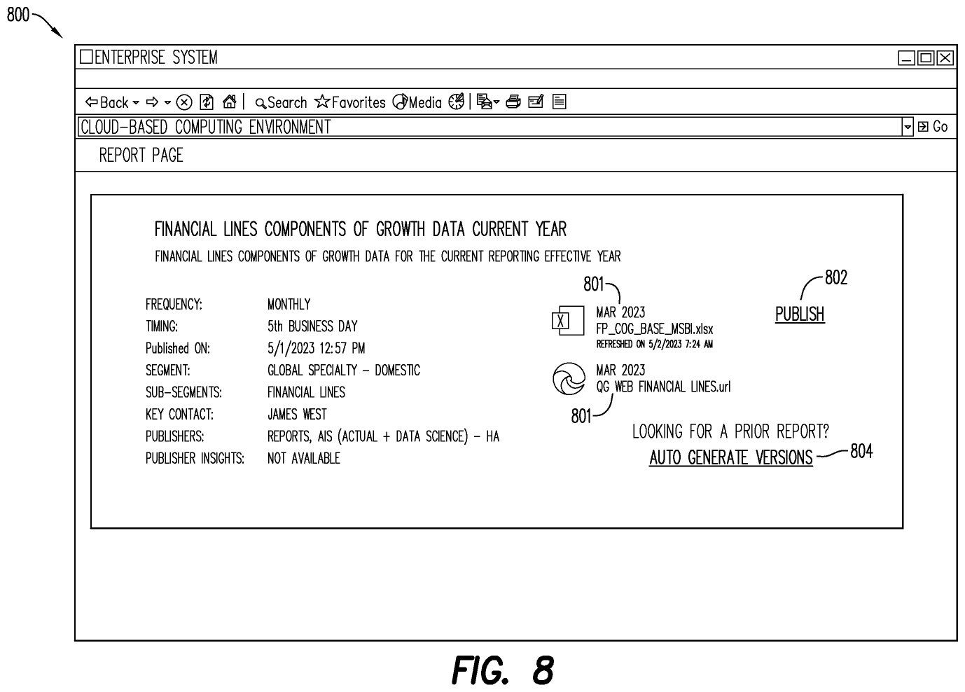

Selection of the embedded report name link 702 may result in the graphical user interface Report Details Page display 800 of FIG. 8 according to some embodiments. One of the differences between the Report Details Page display 600 of FIG. 6 and the Report Details Page display 800 of FIG. 8 is that the display 600 of FIG. 6 is presented to a non-publisher user, while the display 800 of FIG. 8 is presented to the publisher of that report for validation.

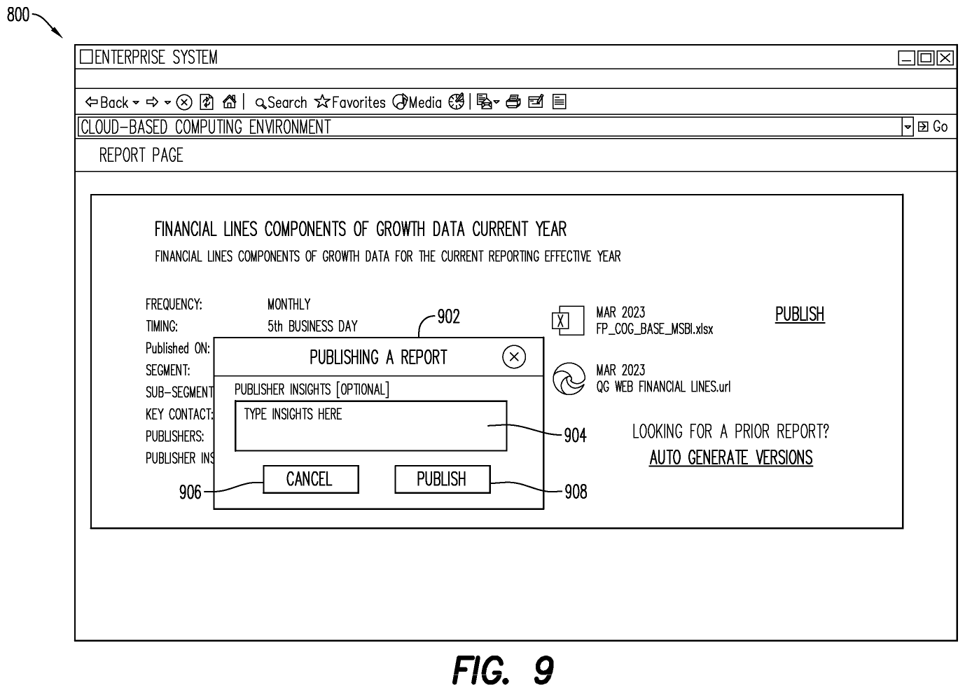

The display 800 in FIG. 8, like the display 600 of FIG. 6, includes reports 801 that may be selected for further review. The display 800 in FIG. 8 also includes an embedded “Publish” link 802. Selection of the embedded “Publish” link 802 may result in a pop-up “Publishing a report” window 902 as shown in FIG. 9. The publisher may add, in a comment box 904, an insight and/or comment to the report that will be displayed in the details 608 (“Publisher Insights”) of the display 600 of FIG. 6. The “Publishing a report” window 902 may include a “Cancel” icon 906 and a “Publish” icon 908. Selection of the “Publish” icon 908 will result in publication of the report so that it is accessible to non-publisher users. The “Publish” icon 908 may be selected in a case a comment is included in the comment box 904 and in a case a comment is absent from the comment box 904, as inclusion of a comment may be optional. Selection of the “Cancel” icon 906 may result in the report not being published at this moment.

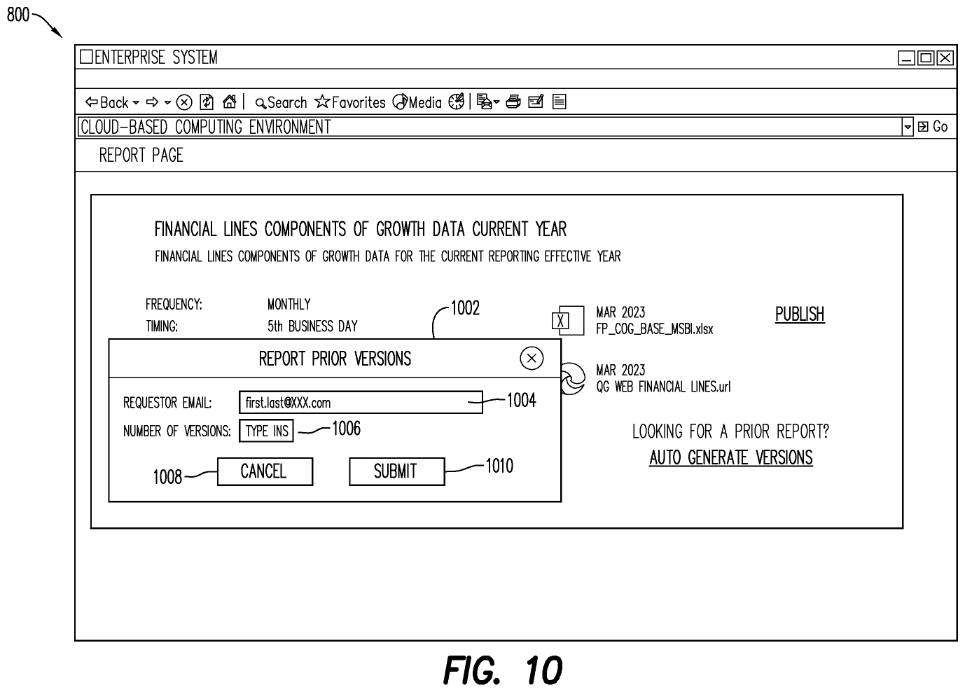

The display 800 in FIG. 8 also includes an embedded “Auto Generate Versions” link 804. As described above with respect to FIG. 6, a user may select the “Prior Report” icon 612 to request a previously generated report of the same report type for display. In response to that request, the publisher may email the prior versions of the report via selection of the embedded “Auto Generate Versions” link 804. It is noted that conventionally, multiple folders are created for a report within a file, where each version of a report is in its own folder, requiring a particular amount of storage. With the integrated delivery platform 130 and according to embodiments, there is a single file with one version of the report, and the number of available prior versions-each in their own file-may be limited based on a pre-defined amount of time the report has been available, reducing the storage and maintenance requirements. Selection of the embedded “Auto Generate Versions” link 804 may result in a pop-up “Report Prior Versions” window 1002 as shown in FIG. 10. The “Report Prior Versions” window 1002 may include a user-entry field for a requestor e-mail address 1004, such that the version may be sent directly to the requestor. In some embodiments, the requestor email address may be pre-populated. The “Report Prior Versions” window 1002 may also include a user-entry field for receipt of a version number 1006. The “Report Prior Versions” window 1002 may include a “Cancel” icon 1008 and a “Submit” icon 1010. Selection of the “Submit” icon 1010 will result in transmission of the requested version to the recipient email address, via the email server 190. Selection of the “Cancel” icon 1008 may result in the report not being transmitted at this moment.

The embodiments described herein may be implemented using any number of different hardware configurations. For example, FIG. 11 illustrates an apparatus 1100 that may be, for example, associated with the system 100 described with respect to FIG. 1. The apparatus 1100 comprises a processor 1110, such as one or more commercially available Central Processing Units (“CPUs”) in the form of one-chip microprocessors, coupled to a communication device 1120 configured to communicate via a communication network (not shown in FIG. 11). The communication device 1120 may be used to communicate, for example, with one or more remote third-party business or economic platforms, administrator computers, insurance agent, and/or communication devices (e.g., PCs and smartphones). Note that communications exchanged via the communication device 1120 may utilize security features, such as those between a public internet user and an internal network of an insurance company and/or an enterprise. The security features might be associated with, for example, web servers, firewalls, and/or PCI infrastructure. The apparatus 1100 further includes an input device 1140 (e.g., a mouse and/or keyboard to enter information about data sources, research data, state data, release dates, etc.) and an output device 1150 (e.g., to output reports regarding schedules, status, alerts, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1115 and/or an application for controlling the processor 1110. The processor 1110 performs instructions of the program 1115, and thereby operates in accordance with any of the embodiments described herein. For example, the processor 1110 may a receive a request for selection of a workflow and retrieve tasks associated with the workflow. The processor 1110 may then automatically execute the workflow and generate a report.

The program 1115 may be stored in a compressed, uncompiled and/or encrypted format. The program 1115 may furthermore include other program elements, such as an operating system, a database management system, and/or device drivers used by the processor 1110 to interface with peripheral devices.

As used herein, information may be “received” by or “transmitted” to, for example: (i) the apparatus 1100 from another device; or (ii) a software application or module within the apparatus 1100 from another software application, module, or any other source.

In some embodiments (such as shown in FIG. 11), the storage device 1130 further includes a workflow data store 1117.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

Although specific hardware and data configurations have been described herein, note that any number of other configurations may be provided in accordance with embodiments of the present invention (e.g., some of the information associated with the displays described herein may be implemented as a virtual or augmented reality display and/or the database described herein may be combined or stored in external systems.) moreover, although embodiments have been described with respect to particular types of enterprises (e.g., an insurance company), embodiments may instead be associated with other types of businesses in addition to and/or instead of those described herein (e.g., financial institutions, universities, governmental departments, etc.). Similarly, although certain attributes were described in connection with some embodiments herein, other types of attributes may be used instead. Sill further, the displays and devices illustrated herein are only provided as examples and embodiments may be associated with any other types of user interfaces.

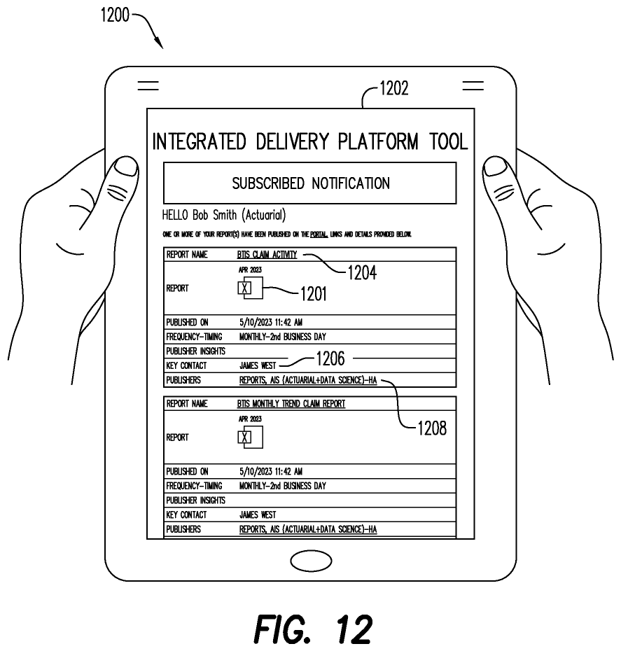

For example, FIG. 12 illustrates a handheld tablet computer 1200 showing a Subscribed Notification message 1202. As described above, a user may subscribe to a particular report. After subscription to the report, in response to a report being updated (e.g., re-executed), the subscribed user may receive a notification message 1202 indicating the report has been updated, without including the report in the notification message. The updated report may be accessed through the notification message 1202 via selection of the report name 1204. Excluding the report from the email may increase available bandwidth. This is unlike conventional systems that include the report delivered directly to their email, which may be inefficient from a bandwidth perspective and makes the system run more slowly across one or more other processes. The notification message 1202 also includes an embedded report link 1201, an embedded key contact link 1206 and an embedded publisher link 1208. As described above, selection of the embedded report link 1201 may result in generation, by the email server 190, per the integrated delivery platform 130, of an email message. As also described above, selection of the embedded key contact link 1206 may result in generation, by the email server 190, per the integrated delivery platform 130, of an email message addressed to the key contact. The email message may also include an embedded link to the report and/or a context for the email. Additionally, the key contact may be a person or a group (e.g., Project_Team). Similarly, selection of one of one or more embedded publisher links 1206 (here, James West) may result in generation, by the email server 190, per the integrated delivery platform 130, of an email message addressed to the selected publisher. The email message communication interface may also include an embedded link to the report and/or a context for the email. It is further noted that selection of any of the report link 1201, embedded key contact link 1206 or the embedded publisher link 1208 may result in generation of a TeamsChat® window, or other suitable communication interface. Pursuant to some embodiments, selection of any of the report link 1201, embedded key contact link 1206 or the embedded publisher link 1208 may result in a pop-up window that provides an email communication icon, a chat communication icon and any other suitable communication icon. In response to selection of the email communication icon, an email message is generated by the email server 190 via the integrated delivery platform 130. In response to selection of the chat communication icon, a chat window is generated by the chat service 195 via the integrated delivery platform 130.

As another non-exhaustive example, the notification message may be an email reminder (not shown) to a publisher in a case they miss publishing a report on a given day per a service-level agreement (SLA). The SLA may define the frequency by which a report is published. In some instances, the timing frequency may be provided by the publisher. With respect to the email reminder notification, the email reminder notification may be sent at noon, or any other suitable time, of the SLA day. Pursuant to embodiments, the rule that triggers the generation and transmission of the notification email reminder may incorporate enterprise holidays. As a non-exhaustive example, the SLA defines the third weekday of the month as publication day for a given report. However, for July, the third weekday of the month is July 4^{th}, so the rule would have the fourth weekday of the month act as the third day for publishing purposes.

As yet another non-exhaustive example, the notification message may be an email alert if a report is delayed and/or unavailable.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system comprising:
an application workflow component to: create and implement one or more workflows;
a database storage component to: provide document management and storage of data received from the application workflow component;
an application development component to: build application products;
an integrated delivery platform to: connect multiple components and exchange component data and Application Programming Interface (API) data with the multiple components;
a backend server component including:
a computer processor;
a computer memory, coupled to the computer processor, storing instructions that, when executed by the computer processor cause the computer processor to:
execute a workflow in connection with an application product and output data;
responsive to the output data, automatically update, via the integrated delivery platform, at least one file of a plurality of files stored in the database storage component with the output data;
generate, based on the output data, at least one report for the updated file;
publish the at least one report; and
a communication port to facilitate a transmission of data with remote user devices in support of a graphical user interface display, including a link to the at least one generated report, via a distributed communication network.

2. The system of claim 1, further comprising instructions to cause the computer processor to:
generate at least two reports for the updated file, wherein the at least two reports have a different report type.

3. The system of claim 2, further comprising instructions to cause the computer processor to:
receive selection of a report type; and
display the report in a selected report type format.

4. The system of claim 1, further comprising instructions to cause the computer processor to:
receive selection of a selectable key contact link on the graphical user interface display; and
generate a communication interface, wherein the communication interface includes a link to the generated report.

5. The system of claim 4, wherein the communication interface is an email message or a TeamsChat® window.

6. The system of claim 1, wherein selection of a report link on the graphical user interface display results in the display of a pop-up window with an email icon and a chat icon and the communication interface is generated in response to selection of one of the email icon and the chat icon.

7. The system of claim 1, wherein the published report displays a publisher comment on the graphical user display.

8. The system of claim 1, wherein the generated at least one report is validated prior to publication.

9. The system of claim 8, wherein a publisher receives a validation request in response to generation of the report.

10. The system of claim 1, further comprising:
a directory-based identity-related services component to: authenticate and authorize enterprise users and computers in a network, and assign and enforce security policies.

11. The system of claim 1, wherein the integrated development platform connects multiple components via a plurality of API endpoints.

12. A computerized method comprising:
creating, via an application workflow component, one or more workflows;
storing, by a database storage component, data received from the application workflow component;
creating, by an application development component, one or more application products;
exchanging, via an integrated delivery platform, Application Programming Interface (API) data with multiple connected components;
executing the created workflow in connection with the application product and outputting data;
responsive to the output data, automatically updating at least one file of a plurality of files stored in the database storage component with the output data;
generating at least one report for the updated file; and
publishing the at least one report.

13. The computerized method of claim 12, further comprising:
connecting, via the integrated delivery platform, the multiple connected components via a plurality of API endpoints.

14. The computerized method of claim 12, further comprising:
generating at least two reports for the updated file, wherein the at least two reports have a different report type.

15. The computerized method of claim 12, further comprising:
receiving selection of one of a selectable email icon and a selectable chat icon provided on a graphical user interface display; and
generating a communication interface based on the selected icon.

16. The computerized method of claim 15, wherein the communication interface is an email message or TeamsChat® window.

17. A non-transitory, computer readable medium storing instructions that, when executed by a processor, cause the processor to perform a method comprising:
creating, via an application workflow component, one or more workflows;
storing, by a database storage component, data received from the application workflow component;
creating, by an application development component, one or more application products;
exchanging, via an integrated delivery platform, Application Programming Interface (API) data with multiple connected components, the API data including one or more API endpoints;
executing the created workflow in connection with the application product and outputting data;
responsive to the output data, automatically updating at least one file of a plurality of files stored in the database storage component with the output data;
generating at least one report for the updated file; and
publishing the at least one report.

18. The medium of claim 17, further comprising:
generating at least two reports for the updated file, wherein the at least two reports have a different report type.

19. The medium of claim 17, further comprising:
receiving selection of a selectable key contact link on a graphical user interface display; and
generating a communication interface, wherein the communication interface includes a link to the generated report.

20. The medium of claim 17 wherein the integrated development platform connects multiple components via a plurality of API endpoints.
